(19) United States
(12) Patent Application Publication
(10) Pub. No.: US 2009/0106106 A1
(43) Pub. Date: Apr. 23, 2009

(54) Method and apparatus for transmitting and receiving IP-based two-way advertisement

(75) Inventors: SangHyeun Lee, Gwangju-city (KR); Bong Tae Kim, Daejeon-city (KR); Ho Young Song, Daejeon-city (KR); Sim Kwon Yoon, Gwangju-city (KR); JaeHun Kim, Jeonju-city (KR); Seung Hun Oh, Gwangju-city (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute

(21) Appl. No.: 12/217,956

(22) Filed: Jul. 10, 2008

(30) Foreign Application Priority Data
Oct. 18, 2007 (KR) 10-2007-0105034

(51) Int. Cl. G06Q 30/00

(52) U.S. Cl. 705/14

(57) ABSTRACT

Provided is a method of transmitting and receiving a two-way advertisement. The method is performed separately from a broadcasting being received by a client. When the client calls for the two-way advertisement, an Internet Protocol (IP)-based two-way advertisement receiving apparatus of the client requests and receives the two-way advertisement from an IP-based two-way advertisement server; stores the two-way advertisement in an advertisement storage unit, wherein the two-way advertisement is transmitted from the IP-based two-way advertisement server which refers to an advertisement area code included in the two-way advertisement and transmits the two-way advertisement by using a multicast group address corresponding to the advertisement area code; and displays the two-way advertisement on a screen of a client using terminal of the client. In the case where the client receives a summary advertisement and desires to obtain more detailed information, the client can receive a detailed advertisement and order a product via the screen.

### CROSS-REFERENCE TO RELATED PATENT APPLICATION

This application claims the benefit of Korean Patent Application No. 10-2007-0105034, filed on Oct. 18, 2007, in the Korean Intellectual Property Office, the disclosure of which is incorporated herein in its entirety by reference.

### BACKGROUND OF THE INVENTION

1. Field of the Invention

The present invention relates to a two-way advertisement method using which a two-way advertisement can be transmitted to a user (hereinafter, referred to as ‘a client) using a unicast method and a multicast method in an Internet Protocol (IP) network and the client can order products online via the two-way advertisement.

2. Description of the Related Art

Developments in communication network technologies and the Internet have come about so that wired/wireless clients can now be provided with various multimedia services such as an Internet based television (TV), Video on demand (VOD), and the like. Accordingly, anew forms of advertisement have been created.

In particular, recent rapid developments in Internet Protocol (IP) TV now enable wired/wireless clients to use various additional services such as Internet information service, MPEG-1 Audio Layer 3 (MP3), moving picture content, IP TV digital broadcasting, and the like by using a monitor or a TV receiver. Also, IP TV is bi-directional as it provides multimedia contents with a packet method using an IP, unlike a general cable broadcasting or a satellite broadcasting which uses a broadcasting radio wave.

Such developments of IP TV and the bi-directionality of IP can be applied to advertisements, thereby making it easy to enable bi-directional advertising. Thus, there is an increasing concern about a new advertisement market called a “two-way advertising”.

Conventionally, an advertisement is unilaterally shown to clients regardless of the clients' purpose, and thus, advertisers do not obtain desired effects. Also, an advertisement via a television (TV) broadcasting is dependently added to broadcasting programs, and thus, the advertisement burdens an advertiser with high costs and the clients cannot immediately watch desired product information.

### SUMMARY OF THE INVENTION

In order to solve the aforementioned problems, the present invention provides a two-way advertisement method which provides a two-way advertisement to a client, wherein the two-way advertisement is separately from an Internet Protocol (IP) TV service used by the client, and which enables online ordering via the two-way advertisement, thereby enabling the client to watch client desired advertisements and information in anytime and to order a product.

Also, when the two-way advertisement is registered, the two-way advertisement method sets an advertisement area code related to the corresponding two-way advertisement so that the two-way advertisement is shown only within an area desired by an advertiser. By doing so, except for a wide area advertisement which is advertised over a wide area, it becomes possible to restrict an advertisement area such that an advertiser having a local small-scale shop can provide an advertisement on TV at low cost.

In addition, the two-way advertisement method can directly connect a client desiring a specific advertisement to an advertiser providing a service corresponding to the specific advertisement, by using bi-directional communication.

According to an aspect of the present invention, there is provided an apparatus for receiving an IP-based two-way advertisement (hereinafter, referred to as ‘IP-based two-way advertisement receiving apparatus), wherein the IP-based two-way advertisement (hereinafter, referred to as ‘two-way advertisement’) is comprised of a summary advertisement intuitively displaying minimum information about a product and a detailed advertisement displaying detailed information about the product, wherein each of the summary advertisement and the detailed advertisement are allocated an advertisement ID (identification) indicating a connection relationship between the summary advertisement, the detailed advertisement, and the product, and wherein the summary advertisement is allocated an advertisement area code indicating an area in which the two-way advertisement is to be received, the IP-based two-way advertisement receiving apparatus including: an advertisement request unit receiving receiving manner information indicating whether a client receives the two-way advertisement using a multicast method or by a unicast method, from an IP-based two-way advertisement server when the client requests the two-way advertisement to the IP-based two-way advertisement server; a receiving unit receiving a summary advertisement with the receiving manner information, wherein the summary advertisement is allocated the advertisement area code matching with a client area code indicating an area where the client receives the two-way advertisement; and a detailed advertisement request unit requesting and receiving a detailed advertisement corresponding to the advertisement ID when the client selects the summary advertisement of detailed information desired by the client.

According to another aspect of the present invention, there is provided an IP-based two-way advertisement server, the IP-based two-way advertisement server including: advertisement containing unit comprising a two-way advertisement which is comprised of a summary advertisement intuitively displaying minimum information about a product and a detailed advertisement displaying detailed information about the product, wherein each of the summary advertisement and the detailed advertisement are allocated an advertisement ID indicating a connection relationship between the summary advertisement, the detailed advertisement, and the product, and wherein the summary advertisement is allocated an advertisement area code indicating an area in which the two-way advertisement is to be received; a multicast transmission unit allocating at least one advertisement area code to one multicast group address, incorporating and transmitting summary advertisements having the allocated advertisement area codes; a unicast transmission unit extracting and transmitting only a summary advertisement having been allocated the advertisement area code matching with a client area code indicating an area where a client receives the two-way advertisement; and a detailed advertisement transmission unit transmitting a detailed advertisement corresponding to the advertisement ID, based on the advertisement ID of the summary advertisement received by the client when the client requests the detailed advertisement.

According to another aspect of the present invention, there is provided a method of receiving a two-way advertisement from an IP-based two-way advertisement receiving apparatus, wherein the two-way advertisement is comprised of a summary advertisement intuitively displaying minimum information about a product and a detailed advertisement displaying detailed information about the product, wherein each of the summary advertisement and the detailed advertisement are allocated an advertisement ID indicating a connection relationship between the summary advertisement, the detailed advertisement, and the product, and wherein the summary advertisement is allocated an advertisement area code indicating an area in which the two-way advertisement is to be received, the method including the operations of receiving receiving manner information indicating whether a client receives the two-way advertisement by a multicast method or by a unicast method, from an IP-based two-way advertisement server when the client requests the two-way advertisement to the IP-based two-way advertisement server; receiving a summary advertisement with the receiving manner information, wherein the summary advertisement is allocated an advertisement area code matching with a client area code indicating an area where the client receives the two-way advertisement; and requesting and receiving a detailed advertisement corresponding to the advertisement ID when the client selects the summary advertisement of detailed information desired by the client.

According to another aspect of the present invention, there is provided a computer readable recording medium having recorded thereon a program for executing the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a configuration of a network system including an Internet Protocol (IP)-based two-way advertisement server, an advertiser, and clients which are grouped according to each area and which use an IP-based two-way advertisement receiving apparatus according to an embodiment of the present invention;

FIG. 2 is a diagram for illustrating a flow with respect to transmitting and receiving a two-way advertisement between an IP-based two-way advertisement server and an IP-based two-way advertisement receiving apparatus according to an embodiment of the present invention;

FIG. 3 is a diagram of an example in which an advertisement area code is allocated, according to an embodiment of the present invention;

FIG. 4 is a diagram of an example in which at least one or more advertisement area codes are allocated to one multicast group address, according to another embodiment of the present invention;

FIG. 5 is a diagram of information about a message flow between a client, an advertiser, an IP-based two-way advertisement server, and an IP-based two-way advertisement receiving apparatus, according to another embodiment of the present invention;

FIG. 6 is a diagram of an internal configuration of a two-way advertisement, according to another embodiment of the present invention;

FIGS. 7A and 7B are examples of an icon advertisement, according to another embodiment of the present invention;

FIG. 8 is an example of a Yellow-Pages advertisement, according to another embodiment of the present invention;

FIG. 9 is an example of a detailed advertisement, according to another embodiment of the present invention;

FIG. 10 is a flowchart of a procedure for transmitting and receiving a two-way advertisement between an IP-based two-way advertisement server and an IP-based two-way advertisement receiving apparatus according to another embodiment of the present invention;

FIG. 11 is a flowchart of a procedure for performing a detailed advertisement request, ordering, and payment based on a Yellow-Pages advertisement according to another embodiment of the present invention;

FIG. 12 is a flowchart of a procedure in which an advertiser obtains information about order and payment from an IP-based two-way advertisement server according to another embodiment of the present invention; and

FIG. 13 is a flowchart of a procedure for connecting an image communication or a phone communication between an advertiser and a client according to another embodiment of the present invention.

### DETAILED DESCRIPTION OF THE INVENTION

The present invention will now be described more fully with reference to the accompanying drawings, in which exemplary embodiments of the invention are shown. Like reference numerals in the drawings denote like elements.

In the following description, well-known functions or constructions are not described in detail since they would obscure the invention with unnecessary detail.

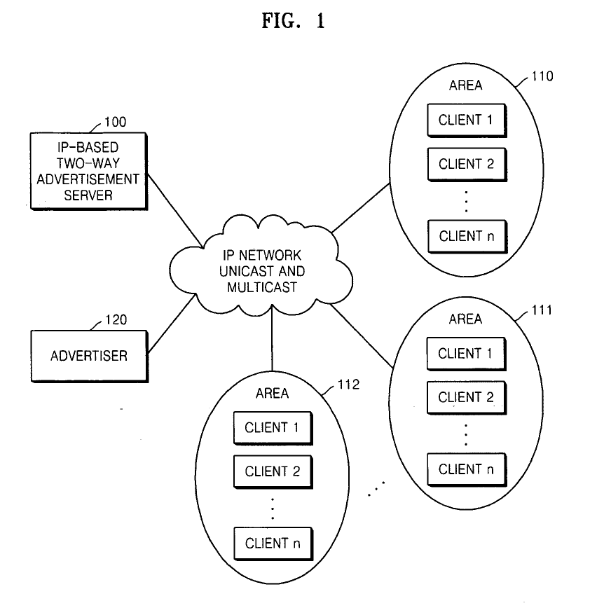

FIG. 1 is a diagram illustrating a configuration of a network system including an Internet Protocol (IP)-based two-way advertisement server 100, an advertiser 120, and clients 110, 111, and 112 which are grouped according to area and which use an apparatus for receiving an IP-based two-way advertisement (hereinafter, referred to as ‘an IP-based two-way advertisement receiving apparatus’).

The network system according to the current embodiment of the present invention includes the IP-based two-way advertisement server 100, the advertiser 120, and the clients 110, 111, and 112 which are grouped according to area. Each of components in the network system is enabled with respect to at least one of a unicast method and a multicast method.

The IP-based two-way advertisement server 100 has a two-way advertisement registered by the advertiser 120, and has client information for receiving the two-way advertisement. In the present invention, a client is a concept corresponding to a server and means a user using the IP-based two-way advertisement receiving apparatus.

The client information includes a client identification (ID), a client area code indicating an area where the client receives the two-way advertisement, a two-way advertisement receiving method of the client, a method of displaying the two-way advertisement on a screen of a client's IP TV terminal by the client, and personal information such as a client address.

Also, the IP-based two-way advertisement server 100 groups the clients 110, 111, and 112 into the same areas according to the client area code. In this manner, since the clients 110, 111, and 112 are grouped into the same areas, the advertiser 120 may select a group when the advertiser 120 registers the two-way advertisement, or may transmit the two-way advertisement only to clients in a specific advertisement area selected by the advertiser 120.

The clients 110, 111, and 112 may receive the two-way advertisement with the multicast method or the unicast method, wherein the two-way advertisement is transmitted from the IP-based two-way advertisement server 100 according to the two-way advertisement receiving method registered in the IP-based two-way advertisement server 100.

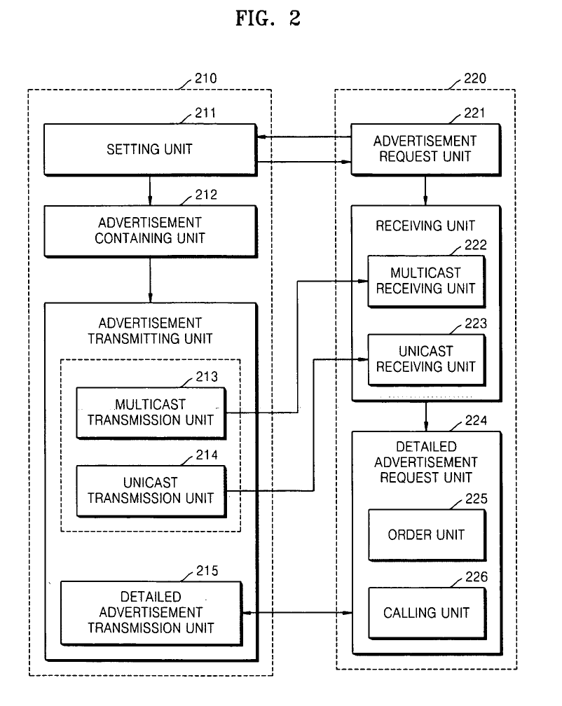

The IP-based two-way advertisement server 100 confirms whether a network system of the area where the client exists supports a multicast transmission, and sets a two-way advertisement receiving manner of the client. A detailed description related to structures of the IP-based two-way advertisement server 100 and the IP-based two-way advertisement receiving apparatus will now be described with reference to FIG. 2.

FIG. 2 is a diagram for illustrating information flow with respect to transmitting and receiving a two-way advertisement between an IP-based two-way advertisement server 210 and an IP-based two-way advertisement receiving apparatus 220 according to an embodiment of the present invention.

The structure of the IP-based two-way advertisement server 210 and the IP-based two-way advertisement receiving apparatus 220 will now be described, and then the information flow with respect to transmitting and receiving the two-way advertisement between the IP-based two-way advertisement server 210 and the IP-based two-way advertisement receiving apparatus 220 will be described.

First, the structure of the IP-based two-way advertisement server 210 is as follows.

The IP-based two-way advertisement server 210 includes a setting unit 211, an advertisement containing unit 212, a multicast transmission unit 213, a unicast transmission unit 214, and a detailed advertisement transmission unit 215.

The setting unit 211 sets a two-way advertisement receiving manner of a client. At this time, the setting unit 211 may set the two-way advertisement receiving manner by referring to whether a network system, where the client exists, supports a multicast method. For example, in the case where the two-way advertisement receiving manner of client A is set as the multicast method, the setting unit 211 allocates a multicast group address thereof. Also, in the case where the two-way advertisement receiving manner of client A is set as a unicast method, the setting unit 211 notifies client A of an IP address of the IP-based two-way advertisement server 210 for requiring the two-way advertisement.

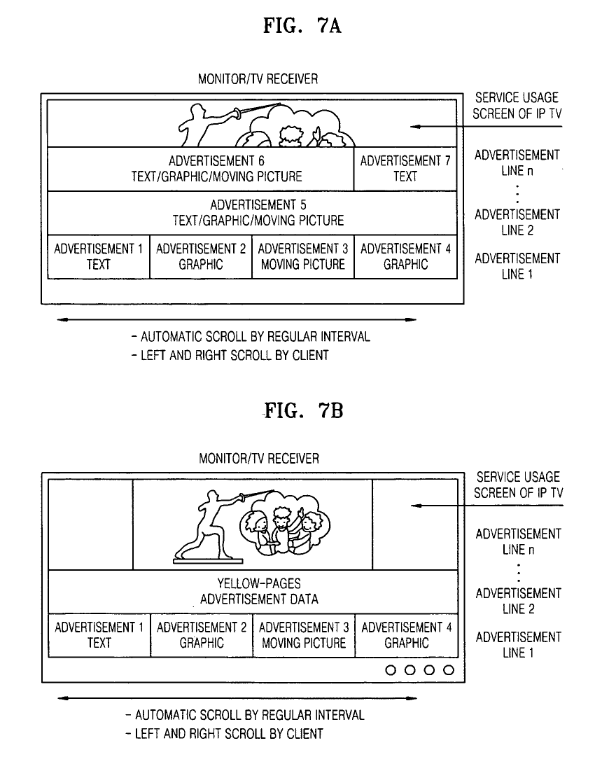

Also, the setting unit 211 may enable the client to set a display method by which the two-way advertisement is displayed on a screen of an IP TV terminal. This will be described with reference to FIGS. 7 through 9.

The advertisement containing unit 212 contains the two-way advertisement registered by an advertiser. The two-way advertisement is composed of a summary advertisement intuitively indicating minimum information of a product and a detailed advertisement indicating detailed information of the product.

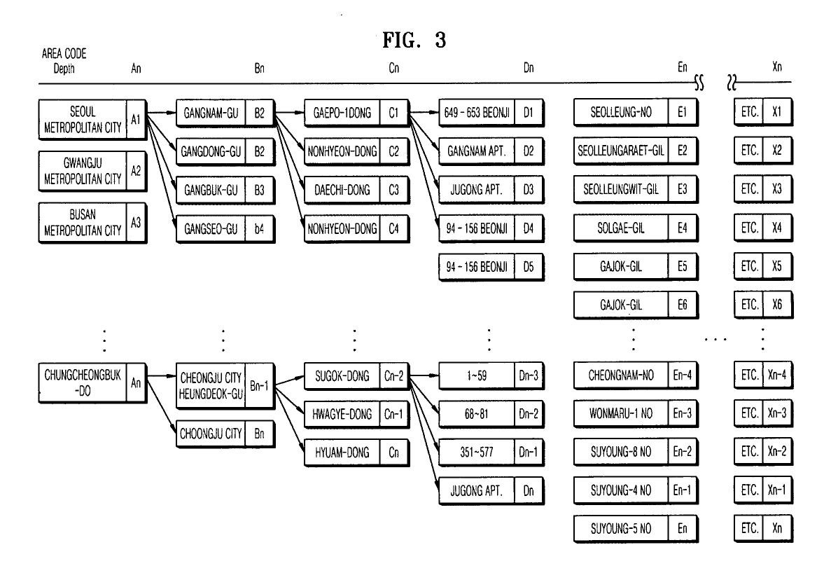

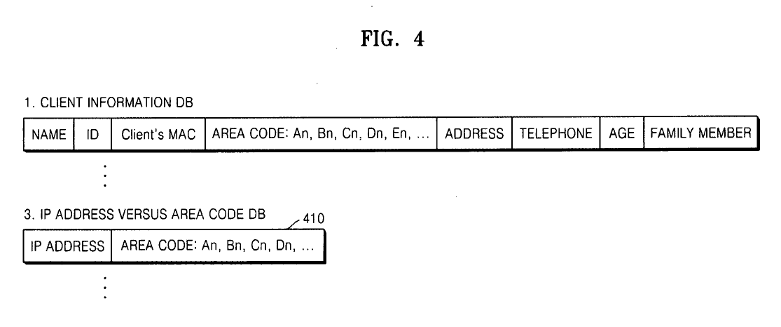

The summary advertisement and the detailed advertisement are respectively allocated an advertisement ID for indicating a connection relationship with the product. The summary advertisement may be allocated at least one advertisement area code indicating an area in which the two-way advertisement is to be received. The advertisement area code may be allocated hierarchically from a wide range area to a small range area, according to an address system. This enables a detailed selection related to the advertisement area to be easy when the advertiser registers the two-way advertisement. Detailed examples thereof will be illustrated in FIGS. 3 and 4.

The summary advertisement includes an icon advertisement which intuitively indicates minimum information of a product, and includes a Yellow-Pages advertisement which intuitively indicates the minimum information of the product and displays the product by classifying the product according to categories. The client may receive the icon advertisement or the Yellow-Pages advertisement based on the form desired by the client.

An advertisement transmitting unit transmits the two-way advertisement contained in the advertisement containing unit 212 by using all of the multicast and unicast methods, or by using one of the multicast and unicast methods, based on information about the two-way advertisement receiving manner (hereinafter, referred to as ‘receiving manner information’) set by the setting unit 211.

The multicast transmission unit 213 allocates at least one advertisement area code to one multicast group address, and integrates and transmits summary advertisements to which the allocated advertisement area code is allowed.

A receiving unit receives only a summary advertisement which is from among one or more summary advertisements transmitted from the multicast transmission unit 213 and in which a client area code matches with the advertisement area code.

To be more specific, an advertisement system operator may include wide areas such as Seoul city, Daegu city, or the like in a multicast group address, and may select more smaller areas such as Gangnam-gu (“gu” implies a large district of a city), Sugok-dong (“dong” implies a neighborhood of a city), or the like in the multicast group address. In the case where an advertiser is from such smaller areas, the advertiser may select a small area, thereby reducing advertisement rates.

In this manner, when various areas are included in the multicast group address and then transmitted to the client, the client filters and receives only a summary advertisement including the advertisement area code matching with the client area code where the client exists. The allocation of at least one advertisement area code to one multicast group address will be illustrated with reference to FIG. 4.

The unicast transmission unit 214 extracts only the summary advertisement having the advertisement area code matching with the client area code, and transmits the two-way advertisement to the client, according to a request from the client.

In the case where the client having received the summary advertisement requests a detailed advertisement, the detailed advertisement transmission unit 215 refers to an advertisement ID of the summary advertisement received by the client, searches for the detailed advertisement corresponding to the advertisement ID, and transmits the detailed advertisement to the client who requested this.

Next, the structure of the IP-based two-way advertisement receiving apparatus 220 is as follows.

The IP-based two-way advertisement receiving apparatus 220 includes an advertisement request unit 221, a receiving unit, and a detailed advertisement request unit 224.

The advertisement request unit 221 requests the two-way advertisement to the IP-based two-way advertisement server 210, and receives the receiving manner information from the IP-based two-way advertisement server 210. The receiving manner information indicates whether the client receives the two-way advertisement by the multicast method or by the unicast method.

In the case where the receiving manner information, received by the advertisement request unit 221, indicates the multicast method, a multicast receiving unit 222 receives the two-way advertisement transmitted from the multicast transmission unit 213 of the IP-based two-way advertisement server 210. The multicast receiving unit 222 filters and receives only the summary advertisement which is from among one or more summary advertisements transmitted from the IP-based two-way advertisement server 210 and to which the advertisement area code matching with the client area code is allocated. That is, the multicast receiving unit 222 extracts only the two-way advertisement, which corresponds to an area where the client exists, by using the client area code. In this case, the client area code is stored in the IP-based two-way advertisement server 210 and the IP-based two-way advertisement receiving apparatus 220.

In the case where the receiving manner information, received by the advertisement request unit 221, indicates the unicast method, a unicast receiving unit 223 receives the summary advertisement transmitted from the unicast transmission unit 214 which has extracted only the summary advertisement including the advertisement area code matching with the client area code of the client who has requested the two-way advertisement.

In the case where the client having received the summary advertisement desires to know more detailed information about the product, the client may request the detailed advertisement corresponding to the advertisement ID, based on the advertisement ID of the summary advertisement, via the detailed advertisement request unit 224. The detailed advertisement request unit 224 requests the detailed advertisement to the detailed advertisement transmission unit 215 in the IP-based two-way advertisement server 210, and the detailed advertisement transmission unit 215 extracts and transmits the detailed advertisement corresponding to the advertisement ID, based on the advertisement ID allocated to the summary advertisement.

When the client having received the detailed advertisement desires to purchase the product, the client may purchase the product on the screen of the IP TV terminal of the client via an order unit 225, wherein the detailed advertisement is displayed on the screen. Also, when the client has an inquiry about the product, the client may call the advertiser via a calling unit 226. The call may be made in telephone or videophone form.

The IP-based two-way advertisement receiving apparatus 220 may further include a display unit (not shown). The display unit may adjust a manner by which the two-way advertisement is displayed on the screen of the IP TV terminal of the client. At this time, the display manner adjusted by the display unit may be also adjusted according to a setting of the setting unit 211 in the IP-based two-way advertisement server 210.

Examples of the display manner adjusted by the display unit are illustrated in FIGS. 7A and 7B in which the two-way advertisement is displayed such that the two-way advertisement is overlaid on a screen of a service program used by the client (FIG. 7A) or the screen of the service program is reduced so that there is no overlaid area (FIG. 7B).

Also, when the summary advertisement is displayed on a screen, the number of output lines may be at least one, and the summary advertisement may be set so as to be automatically scrolled or to be leftward and rightward scrolled by a client manipulation.

The IP-based two-way advertisement receiving apparatus 220 may further include an advertisement storage unit (not shown) storing the received two-way advertisement.

FIG. 3 is a diagram of an example in which an advertisement area code is allocated, according to an embodiment of the present invention.

The advertisement area code may be allocated hierarchically from a wide ranging area to a small ranging area. A detailed example thereof corresponds to the example of FIG. 3. The advertisement area code may be particularly allocated from the wide ranging area such as Seoul metropolitan city A1, Gwangju metropolitan city A2, and Busan metropolitan city A3 to the small ranging area such as Gangnam-gu B1, Gangdong-gu B2, Gangbuk-gu B3, and Gangseo-gu B4.

By allocating the advertisement area code according to the aforementioned manner, an advertiser may selectively select an advertisement target area, thereby reducing advertisement rates from the case where an advertisement is advertised over a wide area. That is, the advertisement target area may be set so that the advertisement is advertised only in an area desired by the advertiser. Thus, not only a wide area advertisement such as a common TV advertisement but also an advertisement of an advertiser having a local small-scale shop may be provided to a monitor or a TV, which are of a client, at low cost.

FIG. 4 is a diagram of an example in which at least one or more advertisement area codes are allocated to one multicast group address, according to another embodiment of the present invention.

A multicast group address denoted as an IP address versus area code database (DB) 410 of FIG. 4 may be allocated a plurality of advertisement area codes, and transmits a summary advertisement having the allocated plurality of advertisement area codes. The plurality of advertisement area codes may be allocated to the multicast group address according to a unit of areas which are hierarchically differentiated. For example, when Seocho-gu is selected from among Gangnam-gu, Gangseo-gu, and Seocho-gu which are all in one side of Seoul city, the advertisement area codes of Seocho, Kyodae, and the like in Seocho-gu may be allocated to the multicast group address.

Also, areas such as Seoul city, Daegu city, Daejeon city, and the like may be allocated to the multicast group address. That is, the areas having equal positions in an address system, or lower areas of the areas may be allocated to the multicast group address.

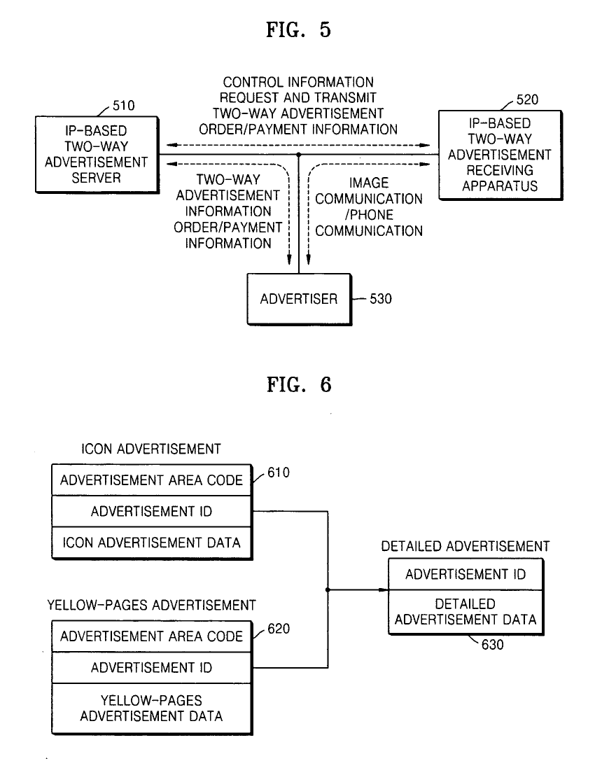

FIG. 5 is a diagram illustrating a message flow between a client, an advertiser 530, an IP-based two-way advertisement server 510, and an IP-based two-way advertisement receiving apparatus 520, according to another embodiment of the present invention.

There is a message flow including control information, a request and a transmission with respect to a two-way advertisement, and information about order and payment, between the IP-based two-way advertisement server 510 and the IP-based two-way advertisement receiving apparatus 520. The control information includes receiving manner information, screen display information of the two-way advertisement, and setting information required so as to transmit and receive the two-way advertisement between the IP-based two-way advertisement server 510 and the IP-based two-way advertisement receiving apparatus 520.

There is a message flow including information about the two-way advertisement to be advertised by the advertiser 530 and the information about the order and the payment related to the two-way advertisement, between the IP-based two-way advertisement server 510 and the advertiser 530. The advertiser 530 connects to the IP-based two-way advertisement server 510 by using a personal computer (PC), and obtains the information about the two-way advertisement registered by the advertiser 530 and a status of order and payment related to a corresponding product.

There is a message flow including an image communication and a phone communication between the IP-based two-way advertisement receiving apparatus 520 and the advertiser 530. The client may perform the image communication or the phone communication with the advertiser 530 of the two-way advertisement, via the IP-based two-way advertisement receiving apparatus 520, while watching the two-way advertisement.

FIG. 6 is a diagram of an internal configuration of a two-way advertisement, according to another embodiment of the present invention.

The two-way advertisement is composed of a summary advertisement and a detailed advertisement 630. The summary advertisement is composed of an icon advertisement 610 and a Yellow-Pages advertisement 620.

The summary advertisement intuitively indicates minimum information about a product, and the detailed advertisement 630 indicates detailed information about the product. In the summary advertisement, the icon advertisement 610 intuitively indicates only the minimum information about the product, and the Yellow-Pages advertisement 620 intuitively indicates the minimum information about the product and displays the product by classifying the product according to categories.

A two-way advertisement of one product is manufactured so as to be composed of the icon advertisement 610 and the Yellow-Pages advertisement 620, and advertisement IDs are respectively allocated to the icon advertisement 610 and the Yellow-Pages advertisement 620, thereby indicating a connection relationship between the product, the icon advertisement 610 and the Yellow-Pages advertisement 620. Also, the icon advertisement 610 and the Yellow-Pages advertisement 620 are allocated an advertisement area code indicating an area in which the two-way advertisement is to be received.

Since the two-way advertisement of one product is manufactured so as to be composed of the icon advertisement 610 and the Yellow-Pages advertisement 620, a client may request detailed information about only a client desired product. Also, an advertiser may select an advertisement target area by inserting one or more advertisement area codes in the summary advertisement.

FIGS. 7A and 7B are examples of an icon advertisement, according to another embodiment of the present invention.

The icon advertisement may incorporate text, graphics, a moving picture, and the like, and may intuitively transfer minimum information about a product desired by an advertiser to a client.

As illustrated in FIG. 7A, the icon advertisement may be displayed on a screen of a service, without affecting the service used by a client via an IP terminal. In this case, a display screen of the icon advertisement may include one or more icon advertisements, and a horizontal length of each icon advertisement may be variable. Also, the number of lines displayed on the screen may be set by an IP-based two-way advertisement server from 1 to nₜₕ number, or a display unit of an IP-based two-way advertisement receiving apparatus may adjust the display screen. The icon advertisement may be scrolled by a regular interval, and may be leftward and rightward scrolled by a client manipulation. In order to view detailed information about a specific two-way advertisement, the client may select the icon advertisement displayed on the screen and may request a detailed advertisement thereof.

As another example, when the icon advertisement is displayed, as illustrated in FIG. 7B, the screen of the service used by the client may be reduced as much as the number of lines related to the icon advertisement such that the icon advertisement may be displayed so as not to cover the screen of the service used by the client.

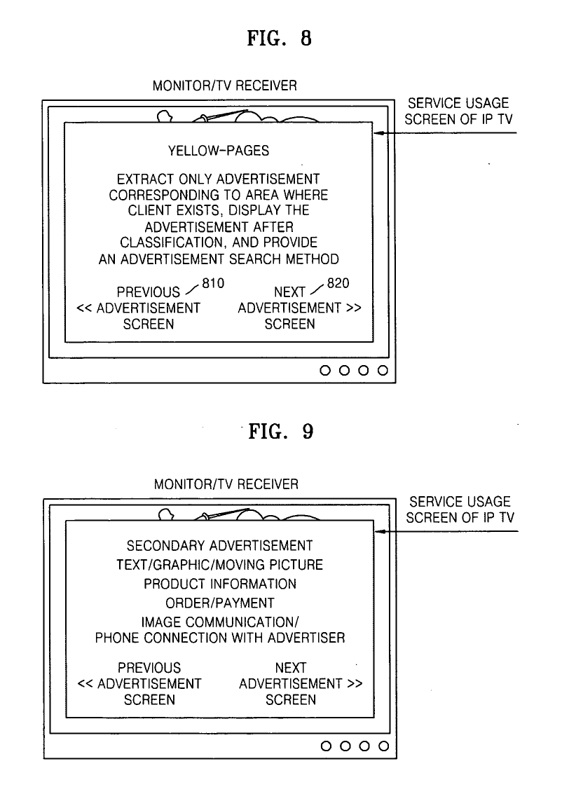

FIG. 8 is an example of a Yellow-Pages advertisement, according to another embodiment of the present invention.

The Yellow-Pages advertisement provides a method by which a specific two-way advertisement may be rapidly searched for by using an advertisement sorting and searching function, without waiting for a desired two-way advertisement to be shown during which the icon advertisement is being scrolled.

A screen of the Yellow-Pages advertisement may partially or entirely cover a screen of a service used by a client. When the number of two-way advertisements displayed on a current screen, exceeds a limit, the screen of the Yellow-Pages advertisement may be made to compose of several pages. At this time, marks for proceeding to a previous advertisement screen 810 or a next advertisement screen 820 are generated on the screen.

FIG. 9 is an example of a detailed advertisement, according to another embodiment of the present invention.

FIG. 9 is an exemplary example of a client screen to which a detailed advertisement is displayed when a specific advertisement is selected from among one of an icon advertisement and a Yellow-Pages advertisement so that the detailed advertisement thereof is requested.

A display format of the detailed advertisement may partially or entirely cover a screen of a service used by a client. Also, a screen of the detailed advertisement may be composed of several pages when the number of pieces of information including detailed information about a product displayed on a current screen, exceeds a limit. At this time, a previous screen and a next screen are marked on the screen.

The detailed advertisement incorporates text, graphics, a moving picture, and the like, and may provide detailed product information related to a two-way advertisement, thereby providing a interface for order and payment to a client. Also, the detailed advertisement provides an interface for an image communication and a phone communication to the client, wherein the interface directly connects the client and an advertiser.

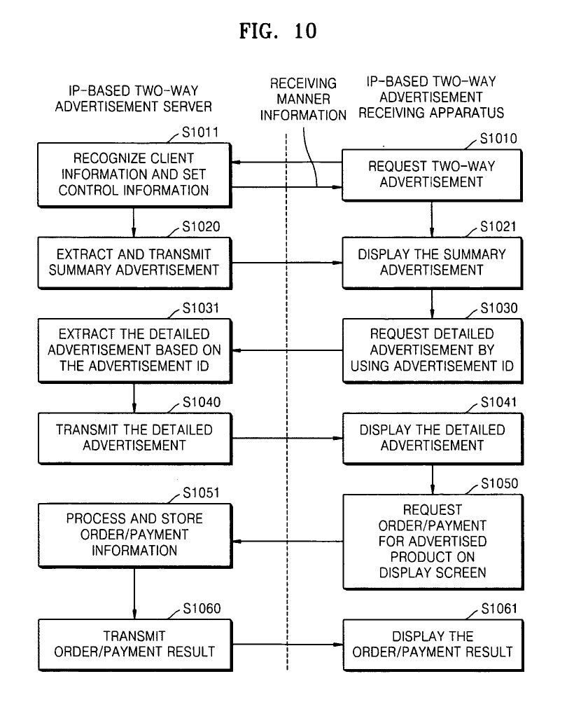

FIG. 10 is a flowchart of a procedure for transmitting and receiving a two-way advertisement between an IP-based two-way advertisement server and an IP-based two-way advertisement receiving apparatus according to another embodiment of the present invention.

When a client using the IP-based two-way advertisement receiving apparatus desires to receive the two-way advertisement, the client requests the two-way advertisement to the IP-based two-way advertisement server (operation S1010). When the IP-based two-way advertisement server receives a transmission request related to the two-way advertisement from the client, the IP-based two-way advertisement server recognizes pre-stored client information, based on a client ID, and the like. After that, the IP-based two-way advertisement server sets control information such as receiving manner information indicating whether the client receives the two-way advertisement by a multicast method or by a unicast method, and information about a method of displaying the two-way advertisement by the client (operation S1011).

The control information set by the IP-based two-way advertisement server is transmitted to the client, and a summary advertisement is transmitted to the client by the multicast method or the unicast method, according to the receiving manner information set by the control information (operation S1020). The client receives only a summary advertisement corresponding to an area where the client exists, and displays the summary advertisement on the IP-based two-way advertisement receiving apparatus used by the client (operation S1021). As described above, in the case of the multicast method, the two-way advertisement is transmitted without a request of the client. In the case of the unicast method, the two-way advertisement is transmitted depending on the request of the client. Also, in the two-way advertisement based on an IP, a multicast summary advertisement is repeatedly transmitted, regardless of the request of the client with respect to the two-way advertisement.

When the client desires to know detailed information about a specific product, while watching the summary advertisement, the client clicks the corresponding summary advertisement by using a remote controller or a keyboard, and requests a detailed advertisement to the IP-based two-way advertisement server by using an advertisement ID allocated to the summary advertisement (operation S1030).

The IP-based two-way advertisement server extracts the detailed advertisement of the specific product, based on the advertisement ID, and transmits the detailed advertisement to the client. The client displays the detailed advertisement on the IP-based two-way advertisement receiving apparatus (operations S1031, S1040, and S1041).

When the client desires to purchase the specific product on a screen on which the detailed advertisement is displayed, the client performs a request related to order and payment. The IP-based two-way advertisement server processes and stores information related to the order and the payment transmitted from the client, thereby transmitting its result to the client. The client may display and confirm the result (operations S1050, S1051, S1060, and S1061).

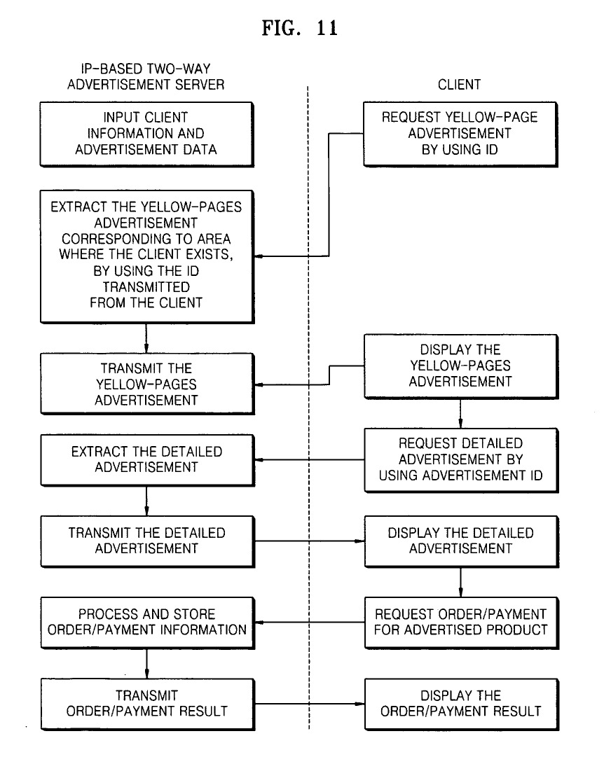

FIG. 11 is a flowchart of a procedure for performing a detailed advertisement request, ordering, and payment based on a Yellow-Pages advertisement according to another embodiment of the present invention.

FIG. 11 corresponds to a procedure in which the Yellow-Pages advertisement is requested from among the summary advertisement of FIG. 10, and then the detailed advertisement is additionally requested based on the Yellow-Pages advertisement, so that a product is ordered.

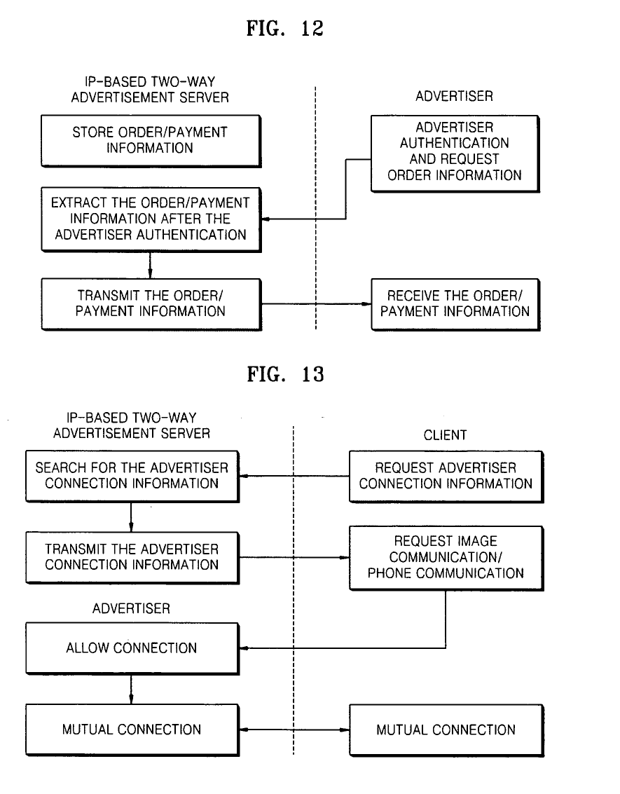

FIG. 12 is a flowchart of a procedure in which an advertiser obtains information about order and payment from an IP-based two-way advertisement server according to another embodiment of the present invention.

The advertiser logs in the IP-based two-way advertisement server after an authentication procedure, and requests order information about a two-way advertisement of the advertiser. The IP-based two-way advertisement server extracts the order information and payment information related to the advertiser, and transmits these to the advertiser.

FIG. 13 is a flowchart of a procedure for connecting an image communication or a phone communication between an advertiser and a client according to another embodiment of the present invention.

When the client desires a communication with the advertiser, while watching a two-way advertisement, the client requests advertiser connect information of the corresponding two-way advertisement to an IP-based two-way advertisement server. The IP-based two-way advertisement server searches for advertiser information and transmits a result thereof to the client. The client requests the advertiser for the image communication or the phone communication. When the advertiser allows the request, the client may be directly connected to the advertiser so as to have a communication. In the case where the advertiser and the client are mutually connected on a screen of a detailed advertisement, a Voice over Internet Protocol (VoIP) may be used.

The present invention enables the client to watch a desired two-way advertisement and desired information in anytime and to order a product. That is, in an IP network environment, the client can watch a two-way advertisement matching with an area (where the client belongs to) at anytime, can communicate with the advertiser via a screen such as an advertisement screen, or can order an advertised product via the screen. By doing so, the present invention which is capable of directly connecting the client and the advertiser can provide the two-way advertisement thus satisfying both a client and an advertiser.

Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for receiving an IP (Internet Protocol)-based two-way advertisement (hereinafter, referred to as ‘IP-based two-way advertisement receiving apparatus’), wherein the IP-based two-way advertisement (hereinafter, referred to as ‘two-way advertisement’) is comprised of a summary advertisement intuitively displaying minimum information about a product and a detailed advertisement displaying detailed information about the product, wherein each of the summary advertisement and the detailed advertisement are allocated an advertisement ID (identification) indicating a connection relationship between the summary advertisement, the detailed advertisement, and the product, and wherein the summary advertisement is allocated an advertisement area code indicating an area in which the two-way advertisement is to be received, the IP-based two-way advertisement receiving apparatus comprising:
an advertisement request unit receiving receiving manner information indicating whether a client receives the two-way advertisement using a multicast method or by a unicast method, from an IP-based two-way advertisement server when the client requests the two-way advertisement to the IP-based two-way advertisement server;
a receiving unit receiving a summary advertisement with the receiving manner information, wherein the summary advertisement is allocated the advertisement area code matching with a client area code indicating an area where the client receives the two-way advertisement; and
a detailed advertisement request unit requesting and receiving a detailed advertisement corresponding to the advertisement ID when the client selects the summary advertisement of detailed information desired by the client.

2. The IP-based two-way advertisement receiving apparatus of claim 1, wherein the receiving unit comprises:
a multicast receiving unit filtering and receiving only a summary advertisement which has an advertisement area code matching with the client area code and which is from among summary advertisements transmitted from the IP-based two-way advertisement server, when the receiving manner information indicates the multicast method; and
a unicast receiving unit receiving the summary advertisement which has an advertisement area code matching with the client area code extracted from the IP-based two-way advertisement server, when the receiving manner information indicates the unicast method.

3. The IP-based two-way advertisement receiving apparatus of claim 1, wherein the client area code is set so as to indicate the area where the client receives the two-way advertisement, according to a client address obtained by using a client ID of the client.

4. The IP-based two-way advertisement receiving apparatus of claim 1, wherein the receiving manner information is set based on whether a network system of the area, where the client receives the two-way advertisement, supports the multicast method.

5. The IP-based two-way advertisement receiving apparatus of claim 1, wherein the advertisement area code is allocated hierarchically from a wide ranging area to a small ranging area, according to an address system.

6. The IP-based two-way advertisement receiving apparatus of claim 1, wherein at least one advertisement area code is allocated to one summary advertisement.

7. The IP-based two-way advertisement receiving apparatus of claim 1, wherein the summary advertisement comprises:
an icon advertisement intuitively displaying minimum information of a product; and
a Yellow-Pages advertisement intuitively displaying the minimum information of the product, and displaying the product by classifying the product according to categories.

8. The IP-based two-way advertisement receiving apparatus of claim 1, further comprising a display unit displaying the received two-way advertisement on a screen of an IP terminal used by the client,
wherein the display unit adjusts a manner by which the two-way advertisement is displayed on the screen.

9. The IP-based two-way advertisement receiving apparatus of claim 1, further comprising:
an order unit ordering the product and performing a payment to the IP-based two-way advertisement server; and
a calling unit creating a phone connection to an advertiser of the product,
wherein functions of the order unit and the calling unit are performed via the screen on which the detailed advertisement is displayed.

10. The IP-based two-way advertisement receiving apparatus of claim 1, further comprising an advertisement storage unit storing the two-way advertisement.

11. An IP-based two-way advertisement server, the IP-based two-way advertisement server comprising:
an advertisement containing unit comprising a two-way advertisement which is comprised of a summary advertisement intuitively displaying minimum information about a product and a detailed advertisement displaying detailed information about the product, wherein each of the summary advertisement and the detailed advertisement are allocated an advertisement ID indicating a connection relationship between the summary advertisement, the detailed advertisement, and the product, and wherein the summary advertisement is allocated an advertisement area code indicating an area in which the two-way advertisement is to be received;
a multicast transmission unit allocating at least one advertisement area code to one multicast group address, incorporating and transmitting summary advertisements having the allocated advertisement area codes;
a unicast transmission unit extracting and transmitting only a summary advertisement having been allocated the advertisement area code matching with a client area code indicating an area where a client receives the two-way advertisement; and
a detailed advertisement transmission unit transmitting a detailed advertisement corresponding to the advertisement ID, based on the advertisement ID of the summary advertisement received by the client when the client requests the detailed advertisement.

12. The IP-based two-way advertisement server of claim 11, further comprising a setting unit transmitting receiving manner information indicating whether a client receives the two-way advertisement by a multicast method or by a unicast method, to a client when the client requests transmission of the two-way advertisement.

13. The IP-based two-way advertisement server of claim 12, wherein one of the multicast transmission unit and the unicast transmission unit transmits the summary advertisement, based on the receiving manner information set by the setting unit.

14. The IP-based two-way advertisement server of claim 11, wherein the client area code is set so as to indicate the area where the client receives the two-way advertisement, according to a client address obtained by using a client ID of the client.

15. The IP-based two-way advertisement server of claim 11, wherein the receiving manner information is set based on whether a network system of the area, where the client receives the two-way advertisement, supports the multicast method.

16. The IP-based two-way advertisement server of claim 11, wherein the advertisement area code is allocated hierarchically from a wide range area to a small range area, according to an address system.

17. The IP-based two-way advertisement server of claim 11, wherein at least one advertisement area code is allocated to one summary advertisement.

18. The IP-based two-way advertisement server of claim 11, wherein the summary advertisement comprises:
an icon advertisement intuitively displaying minimum information of a product; and
a Yellow-Pages advertisement intuitively displaying the minimum information of the product, and displaying the product by classifying the product according to categories.

19. A method of receiving a two-way advertisement from an IP-based two-way advertisement receiving apparatus, wherein the two-way advertisement is comprised of a summary advertisement intuitively displaying minimum information about a product and a detailed advertisement displaying detailed information about the product, wherein each of the summary advertisement and the detailed advertisement are allocated an advertisement ID indicating a connection relationship between the summary advertisement, the detailed advertisement, and the product, and wherein the summary advertisement is allocated an advertisement area code indicating an area in which the two-way advertisement is to be received, the method comprising:
receiving receiving manner information indicating whether a client receives the two-way advertisement by a multicast method or by a unicast method, from an IP-based two-way advertisement server when the client requests the two-way advertisement to the IP-based two-way advertisement server;
receiving a summary advertisement with the receiving manner information, wherein the summary advertisement is allocated an advertisement area code matching with a client area code indicating an area where the client receives the two-way advertisement; and
requesting and receiving a detailed advertisement corresponding to the advertisement ID when the client selects the summary advertisement of detailed information desired by the client.

20. The method of claim 19, wherein the receiving of the summary advertisement comprises:
filtering and receiving only a summary advertisement which comprises the advertisement area code matching with the client area code and which is from among summary advertisements transmitted from the IP-based two-way advertisement server, when the receiving manner information indicates the multicast method; and
receiving the summary advertisement which comprises the advertisement area code matching with the client area code extracted from the IP-based two-way advertisement server, when the receiving manner information indicates the unicast method.

21. The method of claim 19, wherein the client area code is set so as to indicate the area where the client receives the two-way advertisement, according to a client address obtained by using a client ID of the client.

22. The method of claim 19, wherein the receiving manner information is set based on whether a network system of the area, where the client receives the two-way advertisement, supports the multicast method.

23. The method of claim 19, wherein at least one advertisement area code is allocated to one summary advertisement.

24. The method of claim 19, further comprising displaying the received two-way advertisement on a screen of an IP terminal used by the client,
wherein, in the displaying, a manner for displaying the two-way advertisement on the screen is adjusted.

25. The method of claim 19, further comprising:
ordering the product and performing a payment to the IP-based two-way advertisement server; and
creating a phone connection to an advertiser of the product,
wherein the ordering and the performing are performed via the screen on which the detailed advertisement is displayed.
